(19) United States
(12) Patent Application Publication
(10) Pub. No.: US 2005/0089613 A1
(43) Pub. Date: Apr. 28, 2005

(54) Edible testa-on (skin-on) cashew nuts and methods for preparing same

(76) Inventor: Harikrishnan R. Nair, Quilon (IN)

Correspondence Address: HOGAN & HARTSON LLP;IP GROUP, COLUMBIA SQUARE, 555 THIRTEENTH STREET, N.W., WASHINGTON, DC, 20004, US

(21) Appl. No.: 10/689,853

(22) Filed: Oct. 22, 2003

(51) Int. Cl. A23P 1/00

(52) U.S. Cl. 426/482

(57) ABSTRACT

The invention provides edible cashew nuts with intact testa (or skins/husks) remaining on the nut, as well as systems and methods for preparing the same. The process entails reducing levels of inedible chemicals, and in particular tannins and polyphenols, contained in cashew testa to render an edible testa-on cashew product. As part of the chemical removal process the edible testa-on cashew products can be infused and/or coated with a variety of spices and flavorings, including, but not limited to salt, sugar, chocolate, honey and/or other edible materials.

### BACKGROUND OF THE INVENTION

1. Field of the Invention

The invention relates generally to edible cashew nuts and methods for their production and more particularly to edible cashew nuts with intact testa (or skins/husks) remaining on the nut, as well as systems and methods for preparing the same.

2. Discussion of the Related Art

The cashew tree, Anacardium occidentale, is a native of the Amazon region. It was domesticated in South America before the arrival of Europeans at the end of the fifteenth century. Thereafter, it was taken to India and to East and West Africa where it soon became naturalized. Today, cashew trees are grown in almost all the tropical regions of the world. India is the largest producer of cashew nuts, followed by Brazil, Vietnam and a number of countries in East and West Africa. The United States is the largest consumer of cashew nut kernels.

Before harvesting, the “raw” cashew nut is positioned outside and under the cashew fruit (or cashew apple). The cashew fruit is a botanical modification of the peduncle (or stem) and is thus considered a “false fruit.” Despite being a “false fruit,” the cashew apple is edible. Its primary commercial value is as a juice or extract due to its high vitamin C content.

The raw cashew nut is hard and smooth and has a gray or light brown outside color. The outer shell has a honeycomb structure and is approximately 2-3 mm thick. The shell contains a dark reddish-brown, acidic, flammable and inedible oil called Cashew Nut Shell Liquid (CNSL).

Inside the shell is the edible cashew nut covered by a skin, called the testa. The testa is light pink on the outside, brown on the inside and absorbs water. Most research conducted on the constituents of cashew testa occurred prior to 1970 and indicated that cashew testa contain about 32% polyphenols, many of them of the nature of tannins (predominant phenols are catechin and epicatechin (>40%) as well as polymeric proanthocyanidins (slightly less than 40%)). The catechins and epicatechins are water-soluble while other phenols, particularly polymeric phenols, are better extracted with other solvents.

When eaten, cashew testa absorbs saliva and causes the mouth to immediately sense dryness, resulting in a particularly disagreeable, astringent taste (often described as “bitter” or “burning”) due to their high tannin levels. This level of tannins is not reconcilable with a food product. (Tannins are, however, also known to have therapeutic, anti-oxidant qualities and are included among the neutraceuticals. Furthermore, their astringent, dry taste at lower levels (below 5%) is often desirable in many food-products, such as wine and tea.). Thus, cashew testa are always necessarily removed before being eaten and are otherwise considered inedible. In fact, commercial reference to “cashews” or “cashew nuts” generally only refers to testa-free, kidney shaped, white/pale ivory colored cashew nut-kernels.

Conventional systems for cashew nut processing focus primarily on obtaining edible testa-free cashew kernels. The processing of cashew nuts, however, can be sub-divided into “basic processing,” (i.e. obtaining edible, testa-free kernels) and “final processing,” (i.e. processing testa-free kernels into further end-user products).

A. Basic Processing

Traditionally, basic processing of raw cashews is done in the various factories in India, Vietnam, Brazil, Indonesia, Tanzania and other cashew growing countries. Basic processing involves separating the edible kernel from the inedible shell and inedible testa without damaging it. This process is cumbersome and has to be done painstakingly to preserve the edible nut and make it presentable as a final product. The final products are peeled cashews, graded to standards and packed in modified atmosphere bulk-packages that can be stored for up to two years before further processing. The commercial product is called “plain” or “blanched” cashews and is fully edible.

1. Shell Removal (Also Termed Shelling or De-Cortication)

The shell of the cashew nut is hard, but not brittle. It has a honeycomb structure that holds an acidic liquid called Cashew Nut Shell Liquid (CNSL). CNSL is not edible and hence processors do not allow CNSL to contaminate the kernels during shelling. (The main constituents of CNSL (which can also be removed via an oil expeller or solvent extraction) are Anacardic Acid and Cardol. Cardol is refined into Cardanol and can be used in the plastics, automobile, paint and other non-food industries. The isolation, and synthesis of new materials from CNSL has attracted a great deal of attention, and has been the subject of several patents in a number of countries.). As such, shelling poses a more difficult challenge to cashew processors than to processors of other shelled nuts. A number of different procedures are commercially used for shelling cashews, each having pros and cons in terms of processing costs and yield of unblemished kernels. These processes include:

a. Burning the Shell/Impact-Shelling

In this system, the shell with flammable CNSL is set on fire and burned off. After dousing, the burnt shell is brittle, and is knocked off by hand using small mallets and the testa-on kernels are extracted.

b. Sun-Drying the Shell/Impact-Shelling

In this system, the in-shell cashews are sun-dried for several days and the shell is knocked of without further treatment.

c. Osmotic CNSL Extraction/Impact Shelling

In this system, the CNSL is removed via osmotic extraction by passing the raw cashew nuts through a heated, low concentration bath of CNSL. Extraction of the CNSL makes the shell brittle. The shell is then knocked off, either by hand or in an impact-chamber or cut open longitudinally using two or more specially shaped knives and the kernels with their testa are removed.

d. Steam Softening of the Shell/Manual Shell Removal

In this system, raw cashews are steamed to make the shells softer. Thereafter, the shells are individually cut open longitudinally and the cashews are extracted.

Prior to shell removal, in-shell cashew nuts are often sun-dried or soaked with water (i.e. conditioned) for a day or so to improve the yield of intact kernels. Some variations of these procedures and machines for carrying out these processes and for improving the yield of whole, testa-free kernels are patented. The subject matter of this patent application, however, concerns testa-on cashews that can be pre-shelled by any of the above (or other) processes.

2. The “Borma” Drying Process and Peeling

Normally, shelled cashews are dried for between four to nine hours in an oven (also called a “Borma”) at low heat (70-80° C.) to facilitate testa separation from the kernel and to make it easier to peel. Use of low heat prevents the browning or cooking of the kernels. When the heat-distribution within a drying chamber is not well controlled, or when the cashew kernel has prior damage, some of the kernels are “scorched” or discolored. Scorched cashews are considered second quality products and require further cooking before they are called roasted cashews. The aim of the process is to achieve the maximum number of white, whole cashew kernels after peeling with minimal scorching of the kernels. In some cases, the heat in the oven is turned off and the testa-on cashews are left in the humid oven overnight, enabling the dried testa to expand by reabsorbing some of the moisture released by the kernels.

The Borma Process is a “drying” process and should not be confused with a roasting process where the aim is to cook the cashews. The temperature used for roasting nuts is much higher (140-150° C.) and the exposure times are measured in minutes, rather than hours.

In most factories, cashew nuts are hand-peeled individually after drying. In some factories, the testa is removed by mechanical abrasion (e.g. brushes, etc.). Some factories also re-humidify the kernels in a high humidity chamber after the Borma Process to reduce kernel weight loss and also to make the kernels less brittle and less susceptible to breakage while being peeled. Un-peeled cashews, after the drying process or after the re-humidifying process are offered for sale as “Borma Cashews” or as “Natural Wholes” in India. These cashews, however, must be peeled before being eaten because the testa is very astringent, thus making them inedible. Generally, testa-on cashews are not viable in most developed markets because consumers would complain if they accidentally or otherwise ate unpeeled or partly peeled cashews.

3. Cashew Grading

The major cashew nut processing countries have codified grades of plain cashews with detailed standards for each classification. For example, the Indian standards have been compiled by the “Export Inspection Agency” of the Government of India with the Casnew Export Promotion Council of India (www.cashewindia.or). Brazil and Vietnam also have standards that roughly correspond with the Indian standards. Additionally, a UN-ECE world standard has been established in an effort to provide a unified standard, although it is not yet commonly used in trade. The United States Association of Food Importers (www.afius.org) has also codified its own standards for imported cashews based on the source country.

Though not compulsory, these various standards form the backbone of the international trade of edible cashew kernels (as well as the basis of comparison for importation of any raw cashew material in the United States). These grading systems only apply to cashews after they are shelled and peeled (i.e. testa-free cashews). Under these systems, cashews are graded according to color (e.g. white, scorched, scorched seconds/special scorched and dessert), with white being considered premium. All plain cashews are also graded according to whether they are whole or broken. Whole cashews are also graded by count per pound (e.g. 450, 320, 240, 210, 180 and 150) where a smaller count number indicates larger and more preferred kernels. Broken cashews are graded as either splits (halved length-wise), butts (halved cross-wise) and pieces (various mesh-sizes). There are also set tolerances for the maximum percentage of lower grade cashews and broken pieces that can be mixed with whole cashews. Defined defects include cashews with adhering testa and/or foreign matter. Some standards also specify sampling plans, packing material, packing systems, package markings, etc. Some standards also specify tests to check for “uneven roasting.” Significantly, none of these standards mention or apparently contemplate edible testa-on cashews as a final product except in reference to “adhering testa” as objectionable matter.

B. Final Processing

Final processing and consumer packing of edible cashews is mostly done by nut processing companies situated in major commercial markets. Roasting brings out and enhances the flavor of cashews, as with other nuts. Cashews are primarily oil-roasted (i.e. fried in edible oil) before they are consumed. Alternatively, cashews can be dry roasted and lightly coated with edible oil before consumption. Plain, non-roasted cashews have a very light delicate taste and flavor preferred by some consumers while others consider them raw or bland. Plain cashews are marketed as “raw” cashews in the United States.

Cashews as a stand-alone food product may be broadly classified by usage as either (a) snack foods (the largest use) or (b) food ingredients.

1. Cashews as a Snack product

The following are among the many variants of over-the-counter cashew products in various markets: plain (labeled in America as “natural” or “raw”); oil roasted (fried) unsalted; oil roasted (fried) salted; dry roasted unsalted; dry roasted salted; dry or oil roasted with coatings (e.g chocolate, honey, sugar, cinnamon, pepper, chili, garlic, lime and other sweet or savory flavorings and mixes, with or without a flour batter or a food-adhesive); dry or oil roasted with seasonings (e.g. honey, sugar, cinnamon, pepper, chili, garlic, lime and other sweet or savory flavorings and mixes). Other snack food products include cashew paste, butter, etc. that are used as spreads. Different varieties of processed cashews are also often packed in mixtures with other nuts and other dry-snacks. Traditionally, the most popular product is oil-roasted and salted cashews.

2. Cashews as a Food Ingredient

Cashews are extensively used in Indian, Chinese and other Asian cooking. Cashews also find use along with other nuts, in many western food products. In addition to their taste and flavor, cashews are considered a premium food and this perception adds value to food items where “cashews” are a declared ingredient. Generally, raw cashews are used as ingredients where further cooking is contemplated or where the white color or delicate taste is important, such as in ethnic Indian sweets. Broken cashew grades are mostly used as food ingredients, although sometimes cashews are chopped (diced) to pre-determined sizes, sliced or ground into flour or paste. Cashews are also supplied fried, roasted, seasoned or coated for use as toppings for chocolates, ice cream and similar items where there is no further cooking.

### SUMMARY OF THE INVENTION

The invention relates to edible variations of testa-on cashews and systems and methods for preparing the same by the selective removal of inedible chemicals, and in particular tannins, contained in the testa. For the purposes of describing the invention disclosed herein, the terms “inedible chemicals” and “inedible” generally refer to chemical compounds, including but not limited to tannins and polyphenols, that adversely effect the taste of cashew testa and that would not under normal conditions be included in cashew products sold in the edible nut market place.

The invention provides testa-on cashews without significantly affecting the taste of, or imparting any foreign taste to, the cashew kernels. Also, the methods and systems for preparing testa-on cashews facilitates post-shelling processes typically associated with cashew production. Testa-on cashews provide a number of advantages to the consumer and manufacturer, including, but not limited to, health benefits, flavor preservation, cost savings, texture improvements, kernel protection, as well as providing textured surfaces for application of various flavor coatings.

There are many potential benefits related to the invention. In processed food products, consumers place significant value on freshness, hygiene and novelty. In particular, the testa helps preserve more of the roasted flavor in cashews, because, much like coffee beans, the flavors released by roasting dissipate (or escape) over time. Thus, testa-on cashews taste fresher.

Unpeeled nuts, such as almonds, pistachios, filberts (hazel nuts), walnuts and peanuts are appealing to consumers because they look and feel natural. Such nuts project a wholesome image in part because the skin serves a hygienic function by helping ensure the nut kernel has remained untouched by human hands. Testa-on cashews are similarly appealing. Additionally, due to their tannin content, skin-on nuts, and cashews in particular, may have beneficial anti-oxidant properties. Thus, testa-on cashews can be marketed as a health food.

Edible, skin-on cashews are also a unique and novel product because they are not offered for sale anywhere in the world for either direct consumption or as a food ingredient (this lack of availability is largely due to the fact that sellers in developed markets are hesitant to risk having consumers eating even a small part of the skin and thus experiencing its particularly bitter taste). Due to this lack of availability, edible testa-on cashews are a fundamentally new product in the marketplace. In particular, they can be either consumed as a traditional testa-free cashew (if the testa is removed) or they can present a different texture and “bite” to the consumer if eaten testa-on. Furthermore, if sold as a peelable, flavor-infused snack, they give the consumer something to occupy their hands with while they are snacking—a value offered by in-shell peanuts and pistachios.

As an ancillary benefit, the invention also yields isolated tannins for use in, among other things, the leather industry. The commonly used tannin isolation processes involve boiling peeled cashew testa in water, filtering and then evaporating the water. Solvent extraction using aqueous acetone can also be used in this process. Additionally, the phenols extracted from cashew testa can have value in a number of applications, such as food-colorants.

The invention thus provides a process for preparing edible testa-on cashews that includes the steps of exposing shelled testa-on cashews to a solvent, removing inedible chemicals from the testa-on cashews, and drying the testa-on cashews, wherein the chemicals removed were concentrated in the testa of the cashews before application of the process.

The invention further provides a testa-on cashew product having a reduced tannin content, the testa-on cashew made from a process including the steps of exposing shelled testa-on cashews to a solvent, removing inedible chemicals from said testa-on cashews, and drying said testa-on cashews, wherein said chemicals removed were concentrated in the testa of said cashews, before application of the process.

The invention also provides a testa-on cashew product having a tannin content below 10% and a testa-on cashew product having a polyphenol content below 10%.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIG. 1 shows a cashew including a cashew nut, a cashew testa and a cashew shell.

FIG. 2 presents a generalized representation of the processing steps in accordance with an embodiment of the invention.

### DETAILED DESCRIPTION OF THE PREFERRED EMBODIMENTS

Reference will now be made in detail to the preferred embodiments of the invention, examples of which are illustrated in the drawings. This invention may, however, be embodied in many different forms and should not be construed as limited to the embodiments set forth herein. In addition and as will be appreciated by one of skill in the art, the invention may be embodied as a product, method, system or process.

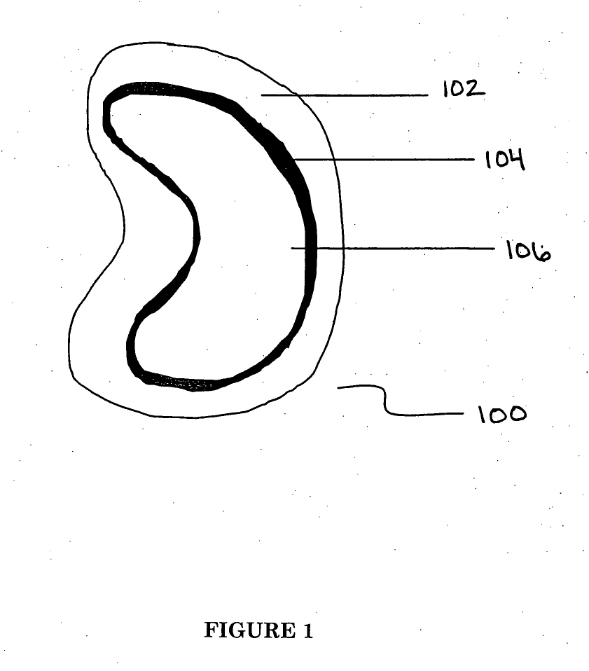

FIG. 1 shows a cashew 100 before processing. The cashew includes a cashew nut 106. A thin outer coating called a testa 104 covers the cashew nut 106. A shell 102 encloses both the testa 104 and the cashew nut 106. As described earlier, the testa 104 typically harbors inedible chemicals and compounds, such as tannins and polyphenols that give a cashew nut a bitter and otherwise undesirable taste unless removed. As described below in greater detail, the invention provides for a testa-on cashew nut having a significantly reduced inedible chemical content thus making the testa-on cashews desirable for eating.

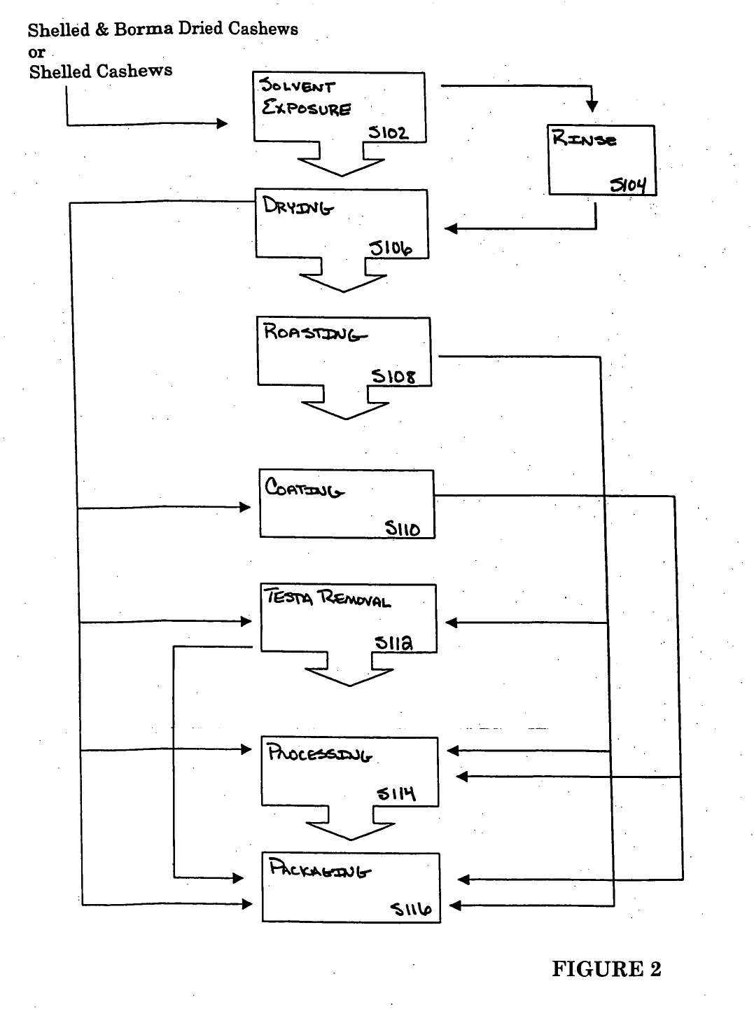

FIG. 2 illustrates the basic process for preparing testa-on cashews in accordance with an embodiment of the invention. In FIG. 2, the process begins at step S102 where either shelled, testa-on cashews or shelled, Borma dried, testa-on cashews are exposed to a solvent. The solvent may include any number of liquids, or combination of liquids, capable of removing inedible chemicals (e.g. polyphenols and tannins) from the cashew testa. These liquids can include, but are not limited to water, aqueous acetone, acetone or other non-poisonous solvents as well as a number of seasoned/flavored/spiced waters (or other solvents) as discussed below. Solvent exposure in step S102 can also include flowing the selected solvent over the testa-on cashews rather than of soaking the testa-on cashews. Additionally, step S102 may include using a solvent at an elevated temperature.

For example, in step S102, the testa-on cashews may be soaked in water for an appropriate amount of time (approximately 20 to 30 minutes, though it can be longer or shorter depending on the testa tannin content and/or the solvent and solvent temperature used) to enable soluble tannins and other offensive chemicals to be removed from the cashew testa. Alternatively, the testa-on cashews can be exposed to a aqueous salt solution (e.g. 25% salt solution for approximately 45 minutes or 15% salt solution for approximately 30 minutes), instead of water. This modified process yields edible salt-infused testa-on cashews. Similarly, it has been observed that use of sugar water and/or other water-miscible spices can produce flavor-infused testa-on cashews. Significantly, these flavor infusion processes yield cashews that are flavored through to the inside of the cashew kernels, as opposed to traditional coatings of flavors limited to the surface of the nuts. In addition to these taste differences, the flavor infused cashews have a different surface appearance than traditionally seasoned cashews.

After step S102, the process can alternatively move to either step S104 or S106. In step S104, the testa-on cashews are very briefly rinsed with water, or another appropriate solvent, to remove excess solvents remaining from step S102. Step S104 can be important when the testa-on cashew are simultaneously flavor infused in step S102 through the use of seasoned/flavored/spiced waters or other solvents.

From either step S102 or S104, the testa-on cashews are dried in step S106 at low heat (e.g. approximately 70° C. for 120 minutes) to remove moisture and obtain plain or flavor infused, edible testa-on cashew kernels. Moisture content is generally reduced to below five percent.

After step S106, the dried testa-on cashews can move to any one or more of the following steps depicted in FIG. 2 (i.e. steps S108, S110, S112, S114, and S116).

In step S108, the testa-on cashews may be roasted using either dry roasting or oil roasting procedures. Roasting through the testa produces very different results from traditional roasting of raw or blanched cashews. The presence of the testa causes the surface to cook differently and some of the volatiles/flavors released by the roasting are fixated in the testa as well as between the surface of the kernel and the testa. This process yields a strong and fresh flavor not otherwise observed in cashews. If subsequently peeled, the surface of the cashews is colored more evenly than after conventional roasting because the testa protects the cashew surface from damage and scrapes that can occur during peeling and subsequent handling prior to roasting. For example, testa-on cashews (plain or infused) are amenable to dry roasting procedures. In one variation, salt-infused testa-on cashews were roasted through to the cashew surface by dry roasting for 80 minutes at 105° C. Similarly, dry roasting testa-on cashews infused with sugar or spices produces a family of roasted, flavored products.

Alternatively, in step S108, testa-on cashews can be fried/oil-roasted. As with dry roasting, cashews infused with salt, sugar, spices or other flavorings can all easily be fried to produce a number of flavored variants. Regardless of the method, roasted testa-on cashews are particularly crunchy compared to roasted testa-free cashews.

In step S110, additional flavorings and coatings can be applied to the testa-on flavored/unflavored, roasted/unroasted cashews. Specifically, testa-on cashews provide a substrate for additional coatings or flavorings. Almonds and peanuts are commonly sold coated with chocolate, candy and various seasonings and flavored flours. Testa-free cashews are not easily coated because of the smooth surface of the nut as well as the curved shape. Testa-on cashews remedy this problem by providing a tactile surface to which materials can adhere. Examples of coating materials include, but are not limited to, sugar, salt, spices, colorings, chocolate, candy, yogurt, honey, flour, other edible materials and combinations thereof.

In step S112, the testa of the testa-on cashews can be removed despite the fact that prior processing steps rendered it edible if the testa-on cashews were previously exposed to the Borma drying process. As described above in conjunction with steps S106 and S108, the presence of the testa during processing and roasting produces a different textured and appearing nut kernel. Accordingly, this differently appearing nut kernel can be served sans testa despite the testa being edible.

In step S114, the cashew products made in the above-described procedures can be further processed. Such further processing can include, but is not limited to, cutting the cashew products into halves and/or pieces, chopping the cashews, dicing the cashews, slicing the cashews, slivering the cashews, preparing cashew meal, preparing cashew paste, preparing other methods of presentation and combinations thereof. For example, cashews prepared by any of the above-described methods can be made into a paste or cashew butter spread. Similarly, testa-on cashew can be offered for sale diced, or sliced to obtain testa-on cashew pieces for use as food ingredients.

Finally, in step S116, the cashews prepared by any of the above methods can be packaged in any of the well-known methods commonly used by commercial nut packagers.

The cashew products produced by the above-described processing steps have an edible testa at all processing steps after solvent exposure in step S102 (except for processed (step S114) and packaged (step S116) products that have their otherwise edible testa removed in step S112). The edible testa-on cashews are characterized as having reduced inedible chemical concentrations in their testa. Specifically, inedible polyphenols and tannins (as well as other chemicals) are removed during solvent exposure in step S102. The testa-on cashew products also are amenable to flavor infusion and to being coated with additional materials (the testa serving as a tactile substrate). Similarly, the presence of the testa helps preserve roasted flavors for longer durations than testa-free cashews.

Thus, the invention provides for a testa-on cashew having a reduced polyphenol and/or tannin content.

A number of novel food products are envisioned and have been produced, or can be, by the above-described processes. These products include, but are not limited to: un-roasted (plain) testa-on cashews; un-roasted salt-infused testa-on cashews; un-roasted sugar-infused testa-on cashews; un-roasted spice/flavoring-infused (e.g. water-miscible spices and mixtures of spices, flavorings, colors, honey, etc.) testa-on cashews; dry-roasted testa-on cashews; dry-roasted salt-infused testa-on cashews; dry-roasted sugar-infused testa-on cashews; dry-roasted spice/flavoring-infused (e.g water-miscible spices and mixtures of spices, flavorings, colors, honey, etc.) testa-on cashews; oil-fried testa-on cashews; oil-fried salt-infused testa-on cashews; oil-fried sugar-infused testa-on cashews; oil-fried spice/flavoring-infused (e.g. water-miscible spices and mixtures of spices, flavorings, colors, honey, etc.) testa-on cashews; un-roasted coated (e.g. sugar, salt, spices, colorings, chocolate, candy, yogurt, honey, flour or other edible materials) testa-on cashews; un-roasted salt-infused coated (e.g. sugar, salt, spices, colorings, chocolate, candy, yogurt, honey, flour or other edible materials) testa-on cashews; un-roasted sugar-infused coated (e.g. sugar, salt, spices, colorings, chocolate, candy, yogurt, honey, flour or other edible materials) testa-on cashews; un-roasted spice/flavoring-infused (e.g. water-miscible spices and mixtures of spices, flavorings, colors, honey, etc.) coated (e.g. sugar, salt, spices, colorings, chocolate, candy, yogurt, honey, flour or other edible materials) testa-on cashews; dry-roasted coated (e.g. sugar, salt, spices, colorings, chocolate, candy, yogurt, honey, flour or other edible materials) testa-on cashews; dry-roasted salt-infused coated (e.g. sugar, salt, spices, colorings, chocolate, candy, yogurt, honey, flour or other edible materials) testa-on cashews; dry-roasted sugar-infused coated (e.g. sugar, salt, spices, colorings, chocolate, candy, yogurt, honey, flour or other edible materials) testa-on cashews; dry-roasted spice/flavoring-infused (e.g. water-miscible spices and mixtures of spices, flavorings, colors, honey, etc.) coated (e.g. sugar, salt, spices, colorings, chocolate, candy, yogurt, honey, flour or other edible materials) testa-on cashews; oil-fried coated (e.g. sugar, salt, spices, colorings, chocolate, candy, yogurt, honey, flour or other edible materials) testa-on cashews; oil-fried salt-infused coated (e.g. sugar, salt, spices, colorings, chocolate, candy, yogurt, honey, flour or other edible materials) testa-on cashews; oil-fried sugar-infused coated (e.g. sugar, salt, spices, colorings, chocolate, candy, yogurt, honey, flour or other edible materials) testa-on cashews; oil-fried spice/flavoring-infused (e.g. water-miscible spices and mixtures of spices, flavorings, colors, honey, etc.) coated (e.g. sugar, salt, spices, colorings, chocolate, candy, yogurt, honey, flour or other edible materials) testa-on cashews; un-roasted peelable testa-on cashews; un-roasted peelable salt-infused testa-on cashews; un-roasted peelable sugar-infused testa-on cashews; un-roasted peelable spice/flavoring-infused (e.g water-miscible spices and mixtures of spices, flavorings, colors, honey, etc.) testa-on cashews; dry-roasted peelable testa-on cashews; dry-roasted peelable salt-infused testa-on cashews; dry-roasted peelable sugar-infused testa-on cashews; dry-roasted peelable spice/flavoring-infused (e.g water-miscible spices and mixtures of spices, flavorings, colors, honey, etc.) testa-on cashews; oil-fried peelable testa-on cashews, covered with cashew testa; oil-fried peelable salt-infused testa-on cashews; oil-fried peelable sugar-infused testa-on cashews; oil-fried peelable spice/flavoring-infused (e.g. water-miscible spices and mixtures of spices, flavorings, colors, honey, etc.) testa-on cashews; and variations of the foregoing whether presented as whole cashews or cashew halves, cashew pieces, chopped cashews, diced cashews, sliced cashews, slivered cashews, cashew meal, cashew paste or any other method of presentation of cashews.

### SPECIFIC EXAMPLES

The following embodiments are for illustrative purposes only and are not intended nor should they be interpreted to limit the scope of the application. For the following examples, cashew selection includes selecting shelled testa-on cashews from lots where the levels of defective kernels are very low. Cashews of which the testa is contaminated with Cashew Nut Shell Liquid (CNSL) are sorted and removed. The products described herein were generally intended to be consumed with the testa intact. The following products can also be peeled by hand or other processes and offered as blanched cashews, however, provided the nascent testa-on cashews are subjected to the “Borma Drying” process before solvent exposure.

### Example 1

The nascent testa-on cashews were soaked in pure water at room temperature (approximately about 30° C.) for approximately 20 to 30 minutes. (Alternatively, flowing and/or warm water can used thereby lowering the exposure time.). Tannins were observed to bleed away from the cashew testa whereby the water bath turns a reddish color. During the soaking period, the water was stirred intermittently. It was observed that by adjusting the time and the temperature of the water, the final levels of tannins could be controlled. In particular, it was observed that hot water extracts more tannins.

After removal from the water bath, the cashews were washed in clean flowing water for several seconds. At the end of this process, the cashews had a moisture content of approximately 25%. Moisture content of the testa-on cashews was then reduced to normal levels (approximately 4-4.5%) by slowly drying at about 70° C. for 4 hours. The specific temperature and time required can vary depending on the type of dryer used. Additionally, it was observed that different product textures could be obtained by changing the drying temperature and time.

The resulting kernel inside the testa has a slightly pale yellow color compared to cashews that have not been put through the process. Reducing the water exposure time, however, reduces this slight discoloration.

### Example 2

Following the procedure of Example 1, tannin extraction was accomplished in a concentrated salt solution. Exposure for 45 minutes in a 25% salt-water solution produced salt-infused testa-on cashews with palatable testa. The salt was infused into the cashews, rather than simply deposited on the surface of the nuts as in other procedures. These results are presumably due to porosity of cashew testa and the cashew kernel to water and the extended exposure time. If the cashews are not rinsed as described in Example 1, the resulting testa is saltier than the internal kernel, similar to salted pistachios.

### Example 3

Following the procedures of Example 1, tannin extraction was accomplished in a concentrated sugar solution. Exposure for 45 minutes in a 60% sugar-water solution produced sugar-infused testa-on cashews with palatable testa. The sugar was infused into the cashews, rather than simply deposited on the surface of the nuts as in other procedures. If the cashews are not rinsed as described in Example 1, the resulting testa is sweeter than the internal kernel.

### Example 4

Following the procedures of Example 1, tannin extraction was accomplished in concentrated solutions of various water-miscible spices (or mixtures thereof), flavorings, honey and citric acid. The resulting products were spice/flavoring-infused testa-on cashews with palatable testa. The spices and/or flavorings were infused into the cashews, rather than simply deposited on the surface of the nuts as in other procedures. If the cashews are not rinsed as described in Example 1, the resulting testa is spicier/more flavorful than the internal kernel.

### Example 5

As an alternative to drying the testa-on cashews as described in Example 1, the wet cashews can be dry-roasted at higher temperatures to a desired roast level. A slow dry roasting at 105° C. for 80 minutes produced an excellent product. The resulting cashew kernels displayed a more even surface coloring than normally dry-roasted testa-free cashews. This improved coloring is likely attributable to the testa helping to evenly distribute the heat on the cashew surface. It was observed that the presence of the testa protects the cashew surface from scrapes and abrasions prior to roasting and this lack of surface damage facilitates the roasting process. It was also observed that the testa-on cashews developed an enhanced roasted flavor relative to normal testa-free cashews. Unlike testa-free cashews, the roasted flavor was preserved for several weeks. Presumably, the presence of the testa helps maintain the fresh roasted flavor of the nuts released during roasting.

### Example 6

As an alternative to drying the salt-infused testa-on cashews as described in Example 2, the salt-infused cashews can be dry roasted at higher temperatures to a desired roast level. A slow dry roasting at 105° C. for 80 minutes produced an excellent product. The resulting salt-infused cashew kernels displayed a more even surface coloring than peeled dry-roasted testa-free cashews. It was also observed that the salt-infused roasted cashews developed an enhanced roasted flavor compared to peeled dry-roasted cashews.

### Example 7

As an alternative to drying the sugar-infused testa-on cashews as described in Example 3, the sugar-infused cashews can be dry-roasted at higher temperatures to a desired roast level. A slow dry roasting at 105° C. for 80 minutes produced an excellent product. The resulting sugar-infused cashew kernels displayed a more even surface coloring than peeled roasted testa-free cashews. It was also observed that the sugar-infused dry roasted cashews developed an enhanced roasted flavor compared to peeled dry-roasted cashews.

### Example 8

As an alternative to drying the spice/flavoring-infused testa-on cashews as described in Example 4, the spice/flavoring-infused cashews can be dry-roasted at higher temperatures to a desired roast level. A slow dry roasting at 105° C. for 80 minutes produced an excellent product. The resulting spice/flavoring-infused cashew kernels displayed a more even surface coloring than peeled dry-roasted testa-free cashews. It was also observed that the spice/flavoring-infused roasted cashews developed an enhanced roasted flavor compared to peeled dry-roasted cashews.

### Example 9

The testa-on cashews prepared in Example 1 can be fried in edible oil. When fried, the resulting cashew kernels displayed a more even surface coloring than normally oil-fried testa-free cashews. This improved coloring is likely attributable to the testa helping to evenly distributes the heat on the cashew surface. It was observed that the presence of the testa protects the cashew surface from scrapes and abrasions prior to roasting and this lack of surface damage facilitates the oil roasting process. The fried testa-on cashews have a higher oil content on both the testa and kernel surface that may be advantageous for certain uses.

### Example 10

The salt-infused testa-on cashews prepared in Example 2 can be fried in edible oil. When fried, the resulting cashew kernels displayed a more even surface coloring than normally oil-fried testa-free cashews. The fried salt-infused testa-on cashews have a higher oil content on both the testa and kernel surface that may be advantageous for certain uses.

### Example 11

The sugar-infused testa-on cashews prepared in Example 3 can be fried in edible oil. When fried, the resulting cashew kernels displayed a very even surface coloring than normally oil-fried testa-free cashews. The fried sugar-infused testa-on cashews have a higher oil content on both the testa and the kernel surface that may be advantageous for certain uses.

### Example 12

The spice/flavoring-infused testa-on cashews prepared in Example 4 can be fried in edible oil. When fried, the resulting cashew kernels displayed a more even surface coloring than normally oil-fried testa-free cashews. The fried spice/flavoring-infused testa-on cashews have a higher oil content on both the testa and the kernel surface that may be advantageous for certain uses.

### Example 13

Any of the product variations described in the previous Examples can be coated (or enrobed) with sugar, salt, spices, colorings, chocolate, candy, yogurt, honey, flour/dough or an other edible material, using existing processes used for peeled cashews or other nuts. The testa provides a substrate for adhering these coatings because it is textured, unlike the surface of the kernel.

### Example 14

Any of the products described in the previous Examples can be used intact or processed (e.g. chopped, diced, sliced or ground) into smaller sizes for use as food ingredients.

### Example 15

Any of the products described in the previous Examples can be ground into cashew paste/butter. The texture of such testa-on cashew paste/butter is different from that of normal cashew butter.

It will be apparent to those skilled in the art that various modifications and variations can be made in the present invention and specific examples provided herein without departing from the spirit or scope of the invention. Thus, it is intended that the present invention covers the modifications and variations of this invention that come within the scope of any claims and their equivalents.

1. A process for preparing edible testa-on cashews comprising:
(a) exposing shelled testa-on cashews to a solvent;
(b) removing inedible chemicals from said testa-on cashews; and
(c) drying said testa-on cashews;
wherein said chemicals removed are concentrated in the testa of said cashews.

2. The process of claim 1, further comprising the step of rinsing said testa-on cashews.

3. The process of claim 1, further comprising the step of flavor infusing said testa-on cashews, wherein said step of flavor infusing includes at least one of salting, sweetening, sugaring, and spicing.

4. The process of claim 3, wherein said step of exposing shelled testa-on cashews to a solvent and said step of flavor infusing said testa-on cashews occur simultaneously.

5. The process of claim 1, further comprising the step of roasting said testa-on cashews.

6. The process of claim 1, further comprising the step of dry roasting said testa-on cashews.

7. The process of claim 1, further comprising the step of oil roasting said testa-on cashews.

8. The process of claim 1, further comprising the step of coating said testa-on cashews with an additional material.

9. The process of claim 1, further comprising the step of removing said testa from said testa-on cashews after said step of drying said testa-on cashews.

10. The process of claim 1, wherein said chemicals include polyphenols.

11. The process of claim 1, wherein said chemicals include tannins.

12. The process of claim 1, wherein said solvent is at room temperature.

13. The process of claim 1, wherein said solvent is at an elevated temperature.

14. The process of claim 1, wherein said step of exposing shelled cashews to a solvent includes soaking said cashews in a solvent.

15. The process of claim 1, wherein said step of exposing shelled cashews to a solvent includes flowing said solvent over said cashews.

16. The process of claim 1, wherein said step of drying includes drying said testa-on cashews at an elevated temperature.

17. The process of claim 1, wherein said step of drying includes drying said testa-on cashews at 70° C. for 4 hours.

18. The process of claim 1, wherein said step of drying includes drying said testa-on cashews to a moisture content of less than five percent.

19. The process of claim 1, wherein said solvent includes at least one of water, salt water, sugar water, acetone, aqueous acetone, spiced water, flavored water, honey water and aqueous solutions.

20. The process of claim 1, wherein said step of exposing shelled testa-on cashews to a solvent comprises exposure for at least ten minutes in an at least 5% salt solution.

21. The process of claim 1, wherein said step of exposing shelled testa-on cashews to a solvent comprises exposure for at least thirty minutes in an at least 15% salt solution.

22. The process of claim 1, wherein said step of exposing shelled testa-on cashews to a solvent comprises exposure for at least forty-five minutes in an at least 25% salt solution.

23. The process of claim 4, wherein said solvent is one of water, salt water, sugar water, spiced water and flavored water.

24. The process of claim 8, wherein said material is at least one of sugar, powdered sugar, salt, spices, colorings, chocolate, fudge, candy, yogurt, honey, flour, and cinnamon.

25. The process of claim 5, wherein said step of dry roasting said testa-on cashews includes dry roasting at 105° C. for 80 minutes.

26. A testa-on cashew product having a reduced tannin content, the testa-on cashew made from a process comprising the steps of:
(a) exposing shelled testa-on cashews to a solvent;
(b) removing inedible chemicals from said testa-on cashews; and
(c) drying said testa-on cashews;
wherein said chemicals removed are concentrated in the testa of said cashews.

27. The testa-on cashew product of claim 26, wherein said testa-on cashew is roasted.

28. The testa-on cashew product of claim 27, wherein said testa-on cashew product is dry-roasted.

29. The testa-on cashew product of claim 27, wherein said testa-on cashew product is oil-fried.

30. The testa-on cashew product of claim 26, wherein said testa-on cashew product is salt infused.

31. The testa-on cashew product of claim 26, wherein said testa-on cashew product is sugar infused.

32. The testa-on cashew product of claim 26, wherein said testa-on cashew product is flavor infused.

33. The testa-on cashew product of claim 26, wherein said testa-on cashew product is coated with at least one additional material.

34. The testa-on cashew product of claim 33, wherein said additional material is at least one of sugar, powdered sugar, salt, spices, colorings, chocolate, fudge, candy, yogurt, honey, flour, and cinnamon.

35. The testa-on cashew product of claim 26, wherein said testa-on cashew is sold for use as a snack food.

36. The testa-on cashew product of claim 26, wherein said testa-on cashew product is sold for use as an ingredient.

37. The testa-on cashew product of claim 26, wherein said testa-on cashew product is made into a spreadable paste.

38. The testa-on cashew product of claim 26, wherein said testa-on cashew product is consumed after the testa has been removed.

39. A testa-on cashew product with the testa having an inedible chemical content below 10%.

40. A testa-on cashew product with the testa having a tannin content below 10%.

41. A testa-on cashew product with the testa having a polyphenol content below 10%.
